(19) United States
(12) Patent Application Publication
(10) Pub. No.: US 2026/0187584 A1
(43) Pub. Date: Jul. 2, 2026

(54) INTEGRATED SYSTEM FOR ENHANCED RECYCLING AND INCENTIVIZATION

(71) Applicant: Datant Inc., Oakville (CA)

(72) Inventors: Inhyuck KIM, Oakville (CA); Yoo Jung JHON, Richmond Hill (CA)

(73) Assignee: Datant Inc., Oakville (CA)

(21) Appl. No.: 19/006,429

(22) Filed: Dec. 31, 2024

(51) Int. Cl. G06Q 10/30; G06Q 10/0834; G06Q 10/0835

(52) U.S. Cl. CPC G06Q 10/087; G06Q 10/08345; G06Q 10/08355; G06Q 10/30

(57) ABSTRACT

A computing system is disclosed. The computing system includes a processor and a memory coupled to the processor, the memory storing computer-executable instructions that, when executed, may configure the processor to: obtain sensor data of a first sensor disposed inside a storage facility, the sensor data indicating a current fill level of the storage facility; detect a trigger condition based on the obtained sensor data; in response to detecting the trigger condition: identify a first set of transport provider devices based on a location of the storage facility; and transmit, to each of one or more devices of the first set, a message for requesting transport of contents of the storage facility, the message indicating a pickup location and at least one destination location.

### TECHNICAL FIELD

The present disclosure relates to resource management systems and more particularly, to methods for operating a location-based service for managing physical resources.

### BACKGROUND

A resource management system employs a computer network to facilitate identification, tracking, and transfer (e.g., transport) of resources, such as physical resources. Physical resources may encompass various types of tangible objects or materials. An important class of physical resources is recyclables, i.e., materials that can be recycled. Traditional recycling systems often rely on outdated methodologies and are not well-suited for handling ever-increasing volumes of waste and the complex and evolving nature of modern recyclable materials.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for scheduling transport of the contents of a plurality of storage facilities;

FIG. 4 shows, in flowchart form, an example method for generating interactive collection guidance data for presenting on user devices;

FIG. 5 shows, in flowchart form, an example method for providing pickup route data to transport providers;

FIGS. 6A and 6B illustrate an example embodiment of a container for receiving and holding recyclable cups;

FIG. 7 illustrates another example embodiment of a container for receiving and holding recyclable cups; and

FIG. 8 illustrates an example embodiment of a cup dispenser station.

Like reference numerals are used in the drawings to denote like elements and features.

### DETAILED DESCRIPTION OF EMBODIMENTS

In an aspect, a computing system is disclosed. The computing system includes a processor and a memory coupled to the processor. The memory stores computer-executable instructions that, when executed by the processor, may configure the processor to: obtain sensor data of a first sensor disposed on a storage facility, the sensor data indicating a current fill level of the storage facility; detect a trigger condition based on the obtained sensor data; in response to detecting the trigger condition: identify a first set of transport provider devices based on a location of the storage facility; and transmit, to each of one or more devices of the first set, a message for requesting transport of contents of the storage facility, the message indicating a pickup location and at least one destination location.

In some implementations, the instructions, when executed, may further configure the processor to determine a first service cost associated with the transport of the contents of the storage facility, and the message may indicate the first service cost.

In some implementations, determining the first service cost may include determining a distance between the pickup location and the at least one destination location.

In some implementations, identifying the first set of transport provider devices may include: determining a first content type of the contents of the storage facility; and identifying one or more transport providers registered with a first transport service and that have capacity for transporting contents of the first content type.

In some implementations, determining the first content type may include: receiving an image depicting at least one of the contents of the storage facility or an indicator of the contents; and classifying the contents of the storage facility based on processing the image using a trained machine learning model.

In some implementations, identifying the first set of transport provider devices may include identifying one or more transport providers that are currently within a defined geographical region relative to the pickup location.

In some implementations, the defined geographical region may comprise a region bounded by a geographical boundary that is a threshold distance from the pickup location.

In some implementations, identifying the first set of transport provider devices may include identifying one or more transport providers that have a current travel time to the pickup location that is equal to or less than a defined time.

In some implementations, the instructions, when executed, may further configure the processor to: determine that the contents of the storage facility have been collected by a transport provider; and update a collection status of the storage facility.

In some implementations, the first sensor may be an image-based or ultrasonic fill level sensor.

In another aspect, a computer-implemented method is disclosed. The method may include: obtaining sensor data of a first sensor disposed on a storage facility, the sensor data indicating a current fill level of the storage facility; detecting a trigger condition based on the obtained sensor data; in response to detecting the trigger condition: identifying a first set of transport provider devices based on a location of the storage facility; and transmitting, to each of one or more devices of the first set, a message for requesting transport of contents of the storage facility, the message indicating a pickup location and at least one destination location.

In another aspect, a computing system is disclosed. The computing system includes a processor and a memory coupled to the processor. The memory stores computer-executable instructions that, when executed by the processor, may cause the processor to: receive, via a computing device, a first image depicting an object for collection by a transport provider; obtain item data of the collection object based on performing image processing on the first image; determine locations of one or more target storage facilities for receiving the collection object using a current location of the computing device; determine projected collection times for the one or more target storage facilities; and present, via a user interface on the computing device, interactive collection guidance data including at least indications of the locations of the one or more target storage facilities and associated projected collection times.

In some implementations, obtaining item data of the collection object may include at least one of: detecting the collection object in the first image; or classifying the collection object based on processing the image using a trained machine learning model.

In some implementations, the trained machine learning model may comprise a convolutional neural network.

In some implementations, determining locations of the one or more target storage facilities may include: identifying a plurality of storage facilities that are located within a defined geographical region relative to the current location of the computing device; and selecting the one or more target storage facilities from the identified plurality of storage facilities based on defined object storage criteria.

In some implementations, the defined geographical region may comprise a region bounded by a geographical boundary that is a threshold distance from the current location of the computing device.

In some implementations, determining projected collection times for the one or more target storage facilities may include obtaining defined schedule data indicating scheduled pickups at the one or more target storage facilities.

In some implementations, determining projected collection times for the one or more target storage facilities may include: identifying at least one transport provider that is available to collect from a first one of the target storage facilities; computing a projected time of arrival of the at least one transport provider at the first target storage facility.

In some implementations, the collection guidance data may include navigation data for navigating from the current location of the computing device to locations of the one or more target storage facilities.

In some implementations, the collection guidance data may be determined based on at least one of: historical navigation data of the computing device; or past drop-off activities of a user associated with the computing device.

In some implementations, the instructions, when executed, further configure the processor to: determine that the collection object has been collected by a transport provider at a target storage facility; and update a collection status of the target storage facility.

In another aspect, a computer-implemented method is disclosed. The method may include: receiving, via a computing device, a first image depicting an object for collection by a transport provider; obtaining item data of the collection object based on performing image processing on the first image; determining locations of one or more target storage facilities for receiving the collection object using a current location of the computing device; determining projected collection times for the one or more target storage facilities; and presenting, via a user interface on the computing device, interactive collection guidance data including at least indications of the locations of the one or more target storage facilities and associated projected collection times.

In another aspect, a computing system is disclosed. The computing system includes a processor and a memory coupled to the processor. The memory stores computer-executable instructions that, when executed by the processor, may cause the processor to: for each of a plurality of storage facilities in a connected network: obtain sensor data of a first sensor disposed on the storage facility, the sensor data indicating a current fill level of the storage facility; and determine a pickup schedule for the plurality of storage facilities, wherein the determining the pickup schedule includes: identifying a first set of the plurality of storage facilities for pickup scheduling based on the obtained sensor data; determining current locations of a schedule requesting device and the storage facilities of the first set; and determining a pickup route based on the current locations data.

In some implementations, identifying the first set of the plurality of storage facilities may include identifying those storage facilities that are associated with a current fill level exceeding a defined threshold level.

In some implementations, identifying the first set of the plurality of storage facility may include identifying those storage facilities that are associated with at least one of a plurality of storage content types.

In some implementations, determining the pickup schedule may further include determining a priority of pickup based on storage content types associated with the plurality of storage facilities.

In some implementations, determining the pickup route may include identifying a route that is associated with a minimum travel time for pickup at the storage facilities of the first set.

In some implementations, determining the pickup route may include identifying a route that is associated with a minimum travel distance for pickup at the storage facilities of the first set.

In some implementations, the instructions, when executed, may further configure the processor to receive, from the schedule requesting device, a request to obtain an optimal pickup schedule, and the sensor data may be obtained responsive to receiving the request.

In another aspect, a computer-implemented method is disclosed. The method may include: for each of a plurality of storage facilities in a connected network: obtaining sensor data of a first sensor disposed on the storage facility, the sensor data indicating a current fill level of the storage facility; and determining a pickup schedule for the plurality of storage facilities, wherein the determining the pickup schedule includes: identifying a first set of the plurality of storage facilities for pickup scheduling based on the obtained sensor data; determining current locations of a schedule requesting device and the storage facilities of the first set; and determining a pickup route based on the current locations data.

In another aspect, a non-transitory computer-readable storage medium is disclosed. The computer-readable storage medium contains computer-executable instructions thereon which, when executed, may configure a processor to carry out one or more of the methods described herein.

In another aspect, a container for receiving and holding cups is disclosed. The container includes: a cylindrical container body having a first body end and a second body end opposite the first body end, the container body defining a circular opening at the first body end; a circular cover at the second body end, the circular cover forming a closed end of the container body; and a plurality of support rods extending along a length of the container body between the first body end and the second body end, each support rod having a first rod end that is affixed to the first body end and a second rod end that is affixed the second body end, wherein the support rods define an outer frame of the container body.

In some implementations, the circular cover may comprise: an annular outer frame; an annular inner frame, the inner frame being generally co-planar with and having a smaller diameter than the outer frame; and one or more rod segments connecting the inner frame and the outer frame.

In some implementations, the circular cover may comprise: an annular outer frame; and at least one rod segment extending generally parallel to a diameter of the outer frame, the at least one rod segment having both of its ends affixed to the outer frame.

In some implementations, the container may further include at least one circular support ring disposed substantially perpendicular to a longitudinal axis of the container body and affixed to the plurality of support rods at a point between the first body end and the second body end along a length of the container body.

In some implementations, the at least one circular support ring may comprise multiple circular support rings disposed substantially perpendicular to the longitudinal axis of the container body, each support ring being affixed to the support rods at a different point between the first body end and the second body end.

In some implementations, each support rod may define a narrowing portion at the second rod end, the narrowing portion extending radially inward from a circumference of the circular cover.

In another aspect, a cup dispenser station is disclosed. The cup dispenser station includes: two or more containers for receiving cups, each container comprising: a cylindrical container body having a first body end and a second body end opposite the first body end, the container body defining a circular opening at the first body end; a circular cover at the second body end, the circular cover forming a closed end of the container body; and a plurality of support rods extending along a length of the container body between the first body end and the second body end, the support rods being affixed to the first body end and the second body end and defining an outer frame of the container body; a lid receptable detachably affixed to the two or more containers; and a liquid dispenser unit comprising: a liquid receptable for receiving dispensed liquid; and a fluid conveying tube having one end disposed in the liquid receptable..

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example implementations of the present application are not limited to any particular operating system, system architecture, mobile device architecture, server architecture, or computer programming language.

The present application discloses a network-based waste management system that leverages machine learning techniques and Internet-of-Things (IoT) integration for improving recycling efficiency and for promoting collaborative recycling practices. The proposed system comprises a computer network that connects user devices, transport provider devices, and “smart” storage facilities. Advantageously, the system may be customized to account for regional waste management requirements across numerous different geographical regions and consumer behavior patterns.

In an aspect, the proposed system may implement methods for classifying physical resources, such as recyclables. More particularly, the disclosed methods facilitate classification of unlabeled physical resources. By way of example, the system may enable accurate identification of recyclable materials that are not labeled or marked with conventional recycling codes (e.g., barcodes such as QR codes). The system employs various image recognition and/or pattern detection algorithms in classifying waste materials. In some implementations, the system may additionally present, to users of the system, guidance data relating to appropriate disposal methods for recyclables. The guidance data may be generated, for example, based on information determined via analysis of images that depict various physical resources of interest.

In another aspect, the proposed system may integrate Internet-of-Things (IoT) technology for resource management. More particularly, the system leverages use of IoT-enabled devices in coordinating collection and transport of physical resources. The system comprises a network of sensors that are associated with a plurality of storage facilities (e.g., collection or storage containers, recycling bins, drop-off depots, etc.) used for storing physical resources. The IoT-enabled devices of the system facilitate real-time monitoring of fill levels of storage facilities, optimizing collection schedules associated with the storage facilities, and coordinating transport of physical resources by transport providers.

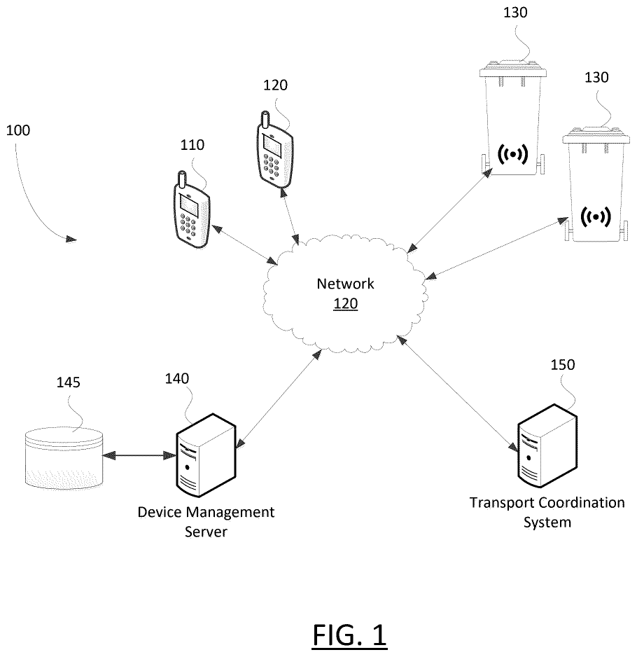

Reference is first made to FIG. 1, which is a schematic diagram illustrating an exemplary networked environment 100 consistent with certain disclosed implementations. As shown in FIG. 1, the networked environment 100 may include user devices 110, transport provider devices 120, a plurality of connected storage facilities 130, a device management server 140, a database 145 associated with the device management server 140, a transport coordination system 150, and a communications network 120 connecting one or more of the components of the networked environment 100. In alternate implementations, the functionalities of each component may be distributed differently from the examples described herein, and the networked environment 100 may include more, fewer, or different components than illustrated in FIG. 1.

The user devices 110 and transport provider devices 120 are computing devices. A transport provider device 120 is a device that is associated with a provider of transport services, such as an operator of a vehicle (e.g., bicycles, delivery or pickup trucks, etc.). The user devices 110 and transport provider devices 120 may take a variety of forms including, for example, a mobile communication device such as a smartphone, a tablet computer, a wearable computer such as a head-mounted display or smartwatch, a laptop or desktop computer, or a computing device of another type. Each user device 110 and transport provider device 120 may store, in memory, software instructions that enable the device to establish communications with one or more of the storage facilities 130, device management server 140, and transport coordination system 150.

The device management server 140 is a computer server associated with a device management service. The device management server 140 is communicably connected to, at least, the user devices 110, transport provider devices 120, and storage facilities 130. The device management server 140 implements one or more device management protocols. In particular, the device management server 140 is configured to send commands and other data, such as software updates, compliance policies, etc., to connected devices. The device management server 140 is also configured to receive, via the connected devices, data which may include sensor output data, device location data, user profile and preference data, and request data of various requests which may be inputted using the user devices 110 and/or transport provider devices 120.

The database 145 stores device data associated with one or more connected devices. In some implementations, the database 145 comprises a cloud-based data store. The database 145 stores various data collected from the user devices 110, transport provider devices 120, and/or storage facilities 130. For example, the database 145 may store device and user identifiers, sensor output data, current and historical location data, etc. associated with the one or more connected devices.

The transport coordination system 150 communicates with various components of the networked environment 100 in order to coordinate timely transport of collection objects by transport providers. More particularly, the transport coordination system 150 is configured to perform various operations for matching transport providers with object collection mandates and/or storage facilities, generating guidance data for user drop-off of objects at storage facilities, and collection object classification. The transport coordination system 150 obtains real-time data from a plurality of sources including fill sensors associated with storage facilities, user and transport provider devices, and the device management server 140. The real-time data may include, without limitation: current fill level; user device location; transport provider device location; image data depicting one or more collection objects; local traffic data; etc. Based on continued monitoring of fill sensor data and device location data, the transport coordination system 150 generates schedule information for object drop-off and/or pickup at selected storage facilities. The schedule information may then be distributed to suitable user and transport provider devices.

The user devices 110, transport provider devices 120, storage facilities 130, device management system 140, and transport coordination system 150 may be in geographically disparate locations. Put differently, the user devices 110 may be remote from at least one of the transport provider devices 120, storage facilities 130, device management system 140, and transport coordination system 150. As described above, each of the user devices 110, transport provider devices 120, device management system 140, and transport coordination system 150 may be a computing device/system.

The communications network 120 is a computer network. In some implementations, the communications network 120 may be an internetwork such as may be formed of one or more interconnected computer networks. For example, the communications network 120 may be or may include an Ethernet network, an asynchronous transfer mode (ATM) network, a wireless network, or the like. The communications network 120 may, in some implementations, include a plurality of distinct networks. For example, communications between certain of the computer systems may be over a private network whereas communications between other of the computer systems may be over a public network, such as the Internet.

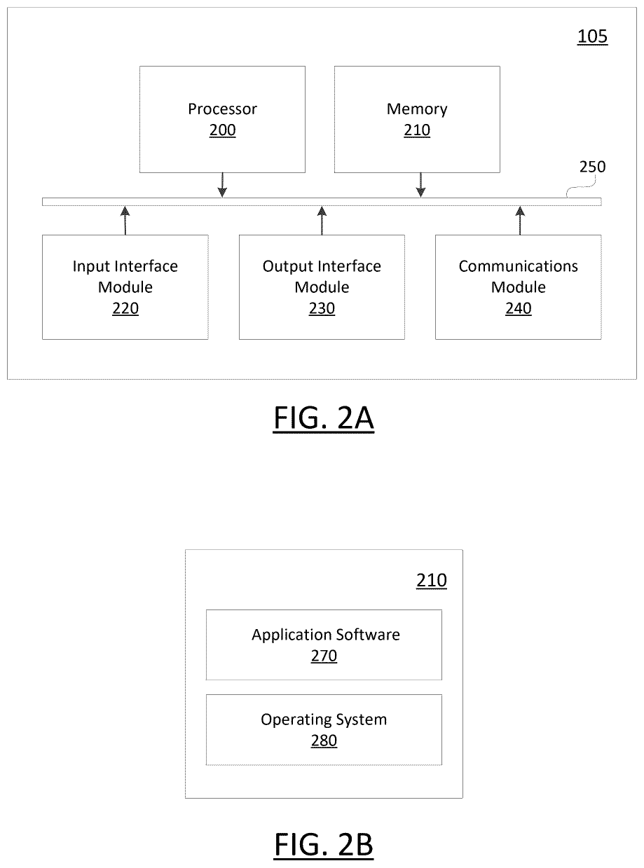

FIG. 2A is a high-level operation diagram of an example computing device 105. In at least some implementations, the example computing device 105 may be exemplary of one or more of the user devices 110, transport provider devices 120, device management system 140, and transport coordination system 150. The example computing device 105 includes a variety of modules. For example, as illustrated, the example computing device 105, may include a processor 200, a memory 210, an input interface module 220, an output interface module 230, multimedia processing module 240 and a communications module 250. As illustrated, the foregoing example modules of the example computing device 105 are in communication over a bus 260.

The processor 200 is a hardware processor. The processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 250 allows the example computing device 105 to communicate with other electronic devices and/or various communications networks. For example, the communications module 250 may allow the example computing device 105 to send or receive communications signals. Communications signals may be sent or received according to one or more protocols or according to one or more standards. For example, the communications module 250 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 250 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 250 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 250. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. For example, the application software 270 may cooperate with the operating system 280 to adapt a suitable embodiment of the example computing device 105 to operate as the client device 110, the backend server 150, or the pinsetter control system 160.

While a single application software 270 is illustrated in FIG. 2B, in operation, the memory 210 may include more than one application software 270 and different application software 270 may perform different operations.

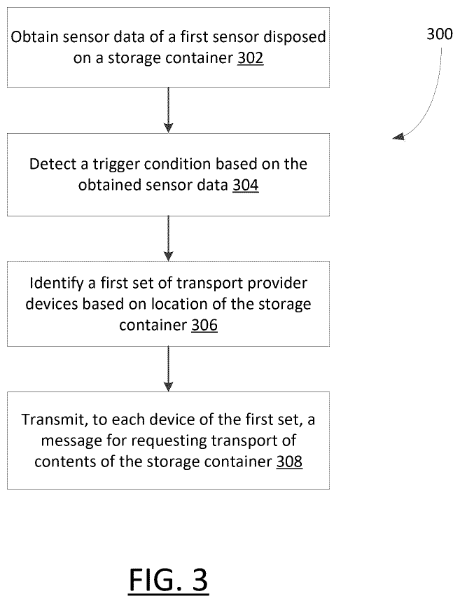

Reference is now made to FIG. 3 which shows, in flowchart form, an example method 300 for scheduling transport of the contents of a plurality of storage facilities. The operations of method 300 may be performed by a computer system that is configured for matching transport providers with transport items, such as the transport coordination system 150 of FIG. 1. In particular, computer-executable instructions stored in a memory, when executed by one or more processors of the computer system, may configure the processor(s) to perform the operations of method 300.

In operation 302, the computer system obtains sensor data of a first sensor disposed on a storage container. The first sensor may be disposed inside the storage container and communicably connected to the computer system. The first sensor may, for example, be an image-based or ultrasonic fill level sensor. The sensor data indicates, at least, a current fill level of the storage container. In particular, the sensor data may comprise information (e.g., measurements) indicating volume fill and/or currently available capacity of the storage container. For example, the sensor data may indicate volume fill percent, peak height of contents, etc. associated with the storage container.

In operation 304, the computer system detects a trigger condition based on the obtained sensor data. The trigger condition relates to a fill level for the storage container. For example, the trigger condition may relate to a threshold level, which may be defined in relative or absolute terms. For example, the threshold level may be defined as a vertical position relative to the interior dimensions of the storage container, or it may be defined as a percentage of the total capacity of the storage container. When the current detected fill level exceeds the threshold level, the contents of the storage container is desired to be emptied and collected. The computer system detects a trigger condition responsive to determining that the current fill level has exceeded the threshold level.

In response to detecting the trigger condition, the computer system identifies a first set of transport provider devices based on a location of the storage container (operation 306). That is, at the time of the trigger detection, one or more transport provider devices are identified. The first set of transport provider devices are devices that are associated with a selected group of transport providers that are suitable for pickup of the contents of the storage container. In at least some implementations, the computer system determines a first content type of the contents of the storage container. For example, the first content type may comprise recyclable wastes. The computer system then identifies one or more transport providers that are registered with a first transport service and that have capacity for transporting contents of the first content type.

The first content type of the contents of the storage container may be identified based on automated image analysis. The computer system may obtain one or more images depicting the contents of the storage container and/or a visual indicator of the contents. The computer system may then classify the contents of the storage container based on processing the image(s) using a trained machine learning model, such as a convolutional neural network (CNN), that is trained on suitable training image data.

The computer system then transmits, to each of one or more devices of the first set, a message for requesting transport of the contents of the storage container (operation 308). The message may indicate a pickup location and at least one destination location. The pickup location may, for example, include information identifying the storage container, and the at least one destination location may be a designated site or facility for object collection/deposit.

The computer system identifies the first set of transport provider devices by, for example, identifying one or more transport providers that are currently within a defined geographical region relative to the pickup location. The computer system may track current locations of a plurality of transport providers and can determine, in real-time, which transport providers are located within a particular geographical region. For example, the computer system may dynamically obtain location data (e.g., GPS data) of one or more transport providers. The defined geographical region may, for example, be a region that is bounded by a geographical boundary that is a threshold distance from the pickup location. By comparing the current location data of transport providers and the geographical boundary associated with the pickup location, the first set of transport providers devices may be identified.

In some implementations, the computer system identifies the first set of transport provider devices based on identifying one or more transport providers that have a current travel time to the pickup location that is equal to or less than a defined time threshold. That is, the first set may include only those devices associated with transport providers that are within a fixed travel time to the pickup location. The computer system may dynamically obtain, by calculating or retrieving from a database, estimated travel times for each transport provider to the pickup location, and the travel times may be compared with a time threshold in order to identify the first set of transport provider devices (for example, by filtering the set of all available transport providers and their associated devices).

In some implementations, the computer system may account for service cost for pickup of the contents of the storage container. The computer system may determine a first service cost associated with the transport of the contents of the storage container, and the message transmitted to the first set of devices indicates the first service cost. The first service cost may be determined based on a distance between the pickup location and the at least one destination location.

The computer system is configured to determine that the contents of the storage container have been collected by a transport provider. For example, when a transport provider collects the contents of a storage container, the computer system may receive a notification (or other indication) of the collection event associated with the storage container. The notification may be received via a computing device associated with the transport provider, such as a mobile device. In response to determining that the contents have been collected, the computer system may update a collection status of the storage container. For example, a database storing collection statuses of a plurality of storage containers may be updated to reflect the collection event associated with the storage container.

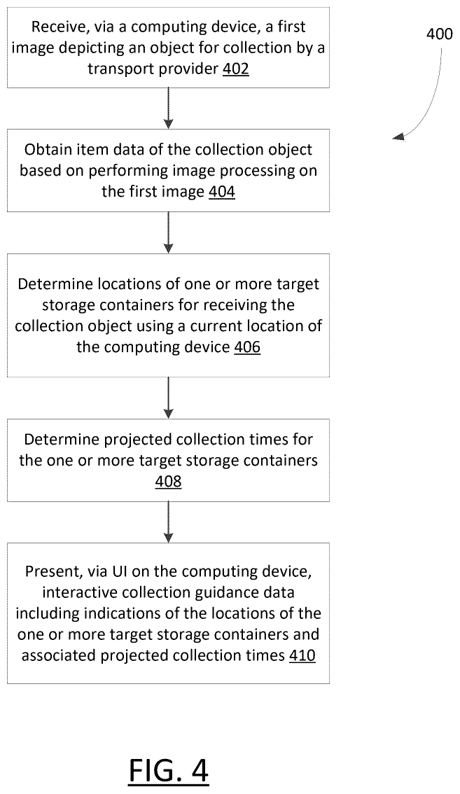

Reference is now made to FIG. 4 which shows, in flowchart form, an example method 400 for generating interactive collection guidance data for presenting on user devices. The method 400 may be implemented by a computer system configured for matching transport providers with transport items, such as the transport coordination system 150 of FIG. 1. The operations of method 400 may be performed in addition to, or as alternatives of, one or more operations of method 300.

In operation 402, the computer system receives, via a computing device, a first image depicting an object for collection by a transport provider. The computing device is associated with a user that handles the object. The first image may be transmitted, for example, via a device (e.g., mobile phone) that is used for capturing the image. In particular, the first image may be captured and uploaded using a suitable software that is resident on the user device.

The computer system then obtains item data of the collection object based on performing image processing on the first image (operation 404). In at least some implementations, the computer system detects the collection object in the first image using one or more object detection algorithms. The computer system then classifies the collection object based on processing the image using a trained machine learning model. The trained machine learning model may, for example, be a convolutional neural network that is trained on suitable training image data.

In operation 406, the computer system determines locations of one or more target storage containers for receiving the collection object using a current location of the computing device. In some implementations, the computer system identifies a plurality of storage containers that are located within a defined geographical region relative to the current location of the computing device. The defined geographical region may, for example, be a region bounded by a geographical boundary that is a threshold distance from the current location of the computing device. The computer system selects the one or more target storage containers from the identified plurality of storage containers based on defined object storage criteria.

In operation 408, the computer system determines projected collection times for the one or more target storage containers. In some implementations, the computer system obtains defined schedule data indicating scheduled pickups at the one or more target storage containers. The projected collection times may be determined based on the obtained schedule data. Additionally, or alternatively, the computer system may identify at least one transport provider that is available to collect from a first one of the target storage containers. The computer system may then compute a projected time of arrival of the at least one transport provider at the first target storage container as part of determining projected collection times for the target storage containers.

In operation 410, the computer system presents, via a user interface on the computing device, interactive collection guidance data. The guidance data includes, at least, indications of the locations of the one or more target storage containers and associated projected collection times. In some implementations, the collection guidance data may comprise navigation data for navigating from the current location of the computing device to locations of the one or more target storage containers. The collection guidance data may be determined, for example, based on at least one of historical navigation data of the computing device or past drop-off activities of a user associated with the computing device.

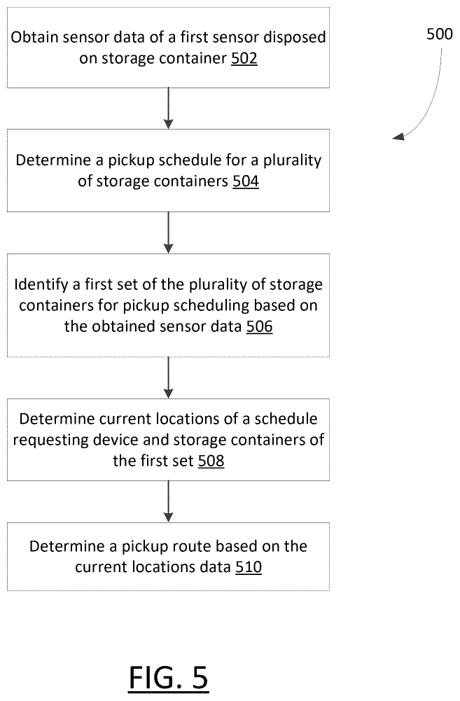

Reference is now made to FIG. 5 which shows, in flowchart form, an example method 500 for providing pickup route data to transport providers. The method 500 may be implemented by a computer system configured for matching transport providers with transport items, such as the transport coordination system 150 of FIG. 1. The operations of method 500 may be performed in addition to, or as alternatives of, one or more operations of methods 300 and 400.

For each of a plurality of storage containers in a connected network, the computer system obtains sensor data of a first sensor disposed on the storage container (operation 502). The sensor data indicates, at least, a current fill level of the storage container. In some implementations, the computer system may receive, from the schedule requesting device, a request to obtain an optimal pickup schedule and the sensor data may be obtained responsive to receiving the request.

In operation 504, the computer system determines a pickup schedule for the plurality of storage containers. As part of determining the pickup schedule, the computer system identifies a first set of the plurality of storage containers for pickup scheduling based on the obtained sensor data (operation 506). In some implementations, the computer system identifies those storage containers that are associated with a current fill level exceeding a defined threshold level. Additionally, or alternatively, the computer system may identify those storage containers that are associated with at least one of a plurality of storage content types.

In operation 508, the computer system determines current locations of a schedule requesting device and the storage containers of the first set. The schedule requesting device may be a user, such as an administrator, that manages the plurality of storage containers. The current locations of the storage containers of the first set may be static and stored in memory that is accessible by the computer system.

In some implementations, the computer system may determine a priority of pickup based on storage content types associated with the plurality of storage containers. That is, an order of pickup of storage contents may be determined as part of determining the pickup schedule.

In operation 510, the computer system determines a pickup route based on the current locations data. By way of example, the computer system may identify one or more routes that are associated with a minimum travel time for pickup at the storage containers of the first set. Alternatively, the computer system may identify routes that are associated with a minimum travel distance for pickup at the storage containers of the first set.

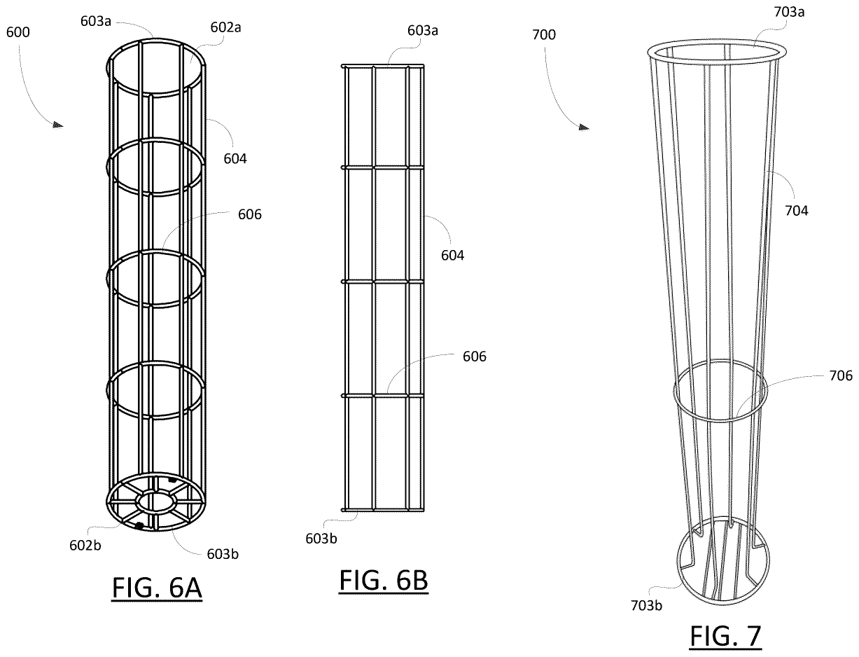

Reference is now made to FIGS. 6A and 6B, which illustrate an example embodiment of a container 600 for receiving cups. The container 600 is generally cylindrical in shape. The container 600 includes a container body that defines a first body end 602a and a second body end 602b opposite to the first body end 602a. The container body defines a circular opening at the first body end 602a. In particular, the container body may include a first ring 603a that is disposed at the first body end 602a.

The container 600 includes a circular cover 603b at the second body end 602b. The circular cover 603b forms a closed end of the container body. In some implementations, the circular cover may include an annular outer frame, an annular inner frame, and one or more rod segments connecting the inner frame and the outer frame. The inner frame may be generally co-planar with and have a smaller diameter than the outer frame, as shown in the embodiment of FIG. 6A. Other configurations of the second body end 602b are contemplated by the present application. The opening at the first body end 602a and the circular cover 603b at the second body end 602b may have the same size or different sizes. For example, the circular opening at the first body end 602a may have a larger radius than the circular cover 603b.

In alternative implementations, the circular cover may include an annular outer frame and at least one rod segment extending generally parallel to a diameter of the outer frame. For example, the at least one rod segment may comprise three or more rod segments. Each rod segment may have both of its ends affixed to the outer frame.

The container also includes a plurality of support rods 604 that extend along a length of the container body between the first body end 602a and the second body end 602b. Each support rod 604 has a first rod end that is affixed to the first body end 603a and a second rod end that is affixed to the second body end 603b. The support rods 604 define an outer frame of the container body. As shown in FIG. 6A, the container 600 may include six or more support rods 604 extending between the body ends 602a and 602b of the container body. The support rods 604 together with the first body end 603a and the second body end 603b define an inner cavity of the container body that is shaped to receive cups, such as paper or other recyclable cups, that can be inserted into the container 600.

In at least some implementations, the container 600 also includes at least one circular support ring 606. The support ring 606 may be disposed substantially perpendicular to a longitudinal axis of the container body and affixed to the plurality of support rods at a point between the first body end and the second body end along a length of the container body. FIGS. 6A and 6B show multiple circular support rings 606 disposed substantially perpendicular to the longitudinal axis of the container body, each support ring being affixed to the support rods at a different point between the first body end and the second body end.

FIG. 7 shows another example embodiment of a container 700 for receiving cups. The container 700 includes a single support ring 706 that is disposed between the first body end 703a and second body end 703b. Each support rod 704 includes a first rod end coupled/affixed to the first body end 703a and a second rod end coupled/affixed to the second body end 703b. In contrast to the container 600 of FIG. 6A, the support rods 704 of container 700 each include a narrowing portion at the second rod end. The narrowing portion is a portion of the support rod 704 adjacent to the second body end 703b that extends radially inward from a circumference of the circular cover, i.e., closed end of the container 700. In effect, each support rod 704 is “bent” to define the narrowing portion at the second rod end. The narrowing portions of the support rods 704 are designed to reduce the cavity of the container body (for receiving cups that inserted into the container 700) at or near the second body end 703b. The support rods 704 define a receiving space for the container 700 that gradually decreases in radius from the first body end 703a towards the second body end 703b.

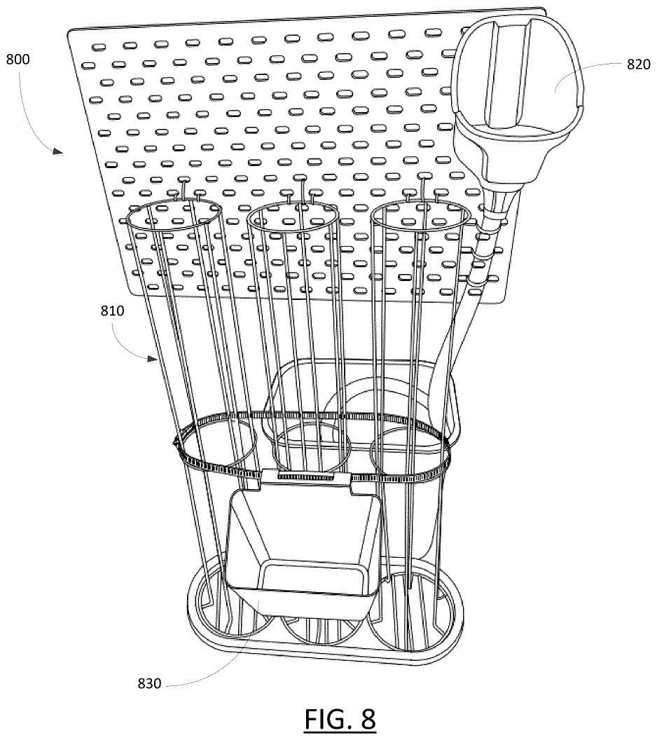

FIG. 8 shows an example embodiment of a cup dispenser station 800. The cup dispenser station 800 includes one or more containers 810 for receiving cups, a liquid dispenser unit 820, and a lid receptable 830. In some implementations, each container 810 may be formed as a container 600 of FIG. 6 or container 700 of FIG. 7. The lid receptable 830 is detachably affixed to the container 810. The lid receptable 830 defines an inner cavity that is sized to receive one or more lids of paper cups. The liquid dispenser unit 820 comprises a liquid receptable for receiving dispensed liquid and a fluid conveying tube having one end disposed in the liquid receptable.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a sub-combination of features which may not be explicitly described above.

In addition, features from one or more of the above-described example implementations may be selected and combined to create alternative example implementations including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a memory coupled to the processor, the memory storing computer-executable instructions that, when executed by the processor, configure the processor to:
obtain sensor data of a first sensor disposed on a storage container, the sensor data indicating a current fill level of the storage container;
detect a trigger condition based on the obtained sensor data;
in response to detecting the trigger condition:
identify a first set of transport provider devices based on a location of the storage container; and
transmit, to each of one or more devices of the first set, a message for requesting transport of contents of the storage container, the message indicating a pickup location and at least one destination location.

2. The computing system of claim 1, wherein the instructions, when executed, further configure the processor to determine a first service cost associated with the transport of the contents of the storage container, wherein the message indicates the first service cost.

3. The computing system of claim 2, wherein determining the first service cost comprises determining a distance between the pickup location and the at least one destination location.

4. The computing system of claim 1, wherein identifying the first set of transport provider devices comprises:
determining a first content type of the contents of the storage container; and
identifying one or more transport providers registered with a first transport service and that have capacity for transporting contents of the first content type.

5. The computing system of claim 4, wherein determining the first content type comprises:
receiving an image depicting at least one of the contents of the storage container or an indicator of the contents; and
classifying the contents of the storage container based on processing the image using a trained machine learning model.

6. The computing system of claim 1, wherein identifying the first set of transport provider devices comprises identifying one or more transport providers that are currently within a defined geographical region relative to the pickup location.

7. The computing system of claim 1, wherein identifying the first set of transport provider devices comprises identifying one or more transport providers that have a current travel time to the pickup location that is equal to or less than a defined time.

8. The computing system of claim 1, wherein the instructions, when executed, further configure the processor to:
determine that the contents of the storage container have been collected by a transport provider; and
update a collection status of the storage container.

9. A computing system, comprising:
a processor;
a memory coupled to the processor, the memory storing computer-executable instructions that, when executed by the processor, configure the processor to:
receive, via a computing device, a first image depicting an object for collection by a transport provider;
obtain item data of the collection object based on performing image processing on the first image;
determine locations of one or more target storage containers for receiving the collection object using a current location of the computing device;
determine projected collection times for the one or more target storage containers; and
present, via a user interface on the computing device, interactive collection guidance data including at least indications of the locations of the one or more target storage containers and associated projected collection times.

10. The computing system of claim 9, wherein obtaining item data of the collection object comprises at least one of:
detecting the collection object in the first image; or
classifying the collection object based on processing the image using a trained machine learning model.

11. The computing system of claim 9, wherein determining locations of the one or more target storage containers comprises:
identifying a plurality of storage containers that are located within a defined geographical region relative to the current location of the computing device; and
selecting the one or more target storage containers from the identified plurality of storage containers based on defined object storage criteria.

12. The computing system of claim 9, wherein determining projected collection times for the one or more target storage containers comprises obtaining defined schedule data indicating scheduled pickups at the one or more target storage containers.

13. The computing system of claim 9, wherein determining projected collection times for the one or more target storage containers comprises:
identifying at least one transport provider that is available to collect from a first one of the target storage containers;
computing a projected time of arrival of the at least one transport provider at the first target storage container.

14. The computing system of claim 9, wherein the collection guidance data comprises navigation data for navigating from the current location of the computing device to locations of the one or more target storage containers.

15. The computing system of claim 9, wherein the collection guidance data is determined based on at least one of:
historical navigation data of the computing device; or
past drop-off activities of a user associated with the computing device.

16. The computing system of claim 9, wherein the instructions, when executed, further configure the processor to:
determine that the collection object has been collected by a transport provider at a target storage container; and
update a collection status of the target storage container.

17. A container for receiving cups, the container comprising:
a cylindrical container body having a first body end and a second body end opposite the first body end, the container body defining a circular opening at the first body end;
a circular cover at the second body end, the circular cover forming a closed end of the container body; and
a plurality of support rods extending along a length of the container body between the first body end and the second body end, each support rod having a first rod end that is affixed to the first body end and a second rod end that is affixed the second body end, wherein the support rods define an outer frame of the container body.

18. The container of claim 17, wherein the circular cover comprises:
an annular outer frame;
an annular inner frame, the inner frame being generally co-planar with and having a smaller diameter than the outer frame; and
one or more rod segments connecting the inner frame and the outer frame.

19. The container of claim 17, wherein the circular cover comprises:
an annular outer frame; and
at least one rod segment extending generally parallel to a diameter of the outer frame, the at least one rod segment having both of its ends affixed to the outer frame.

20. The container of claim 17, further comprising at least one circular support ring disposed substantially perpendicular to a longitudinal axis of the container body and affixed to the plurality of support rods at a point between the first body end and the second body end along a length of the container body.

21. The container of claim 20, wherein the at least one circular support ring comprises multiple circular support rings disposed substantially perpendicular to the longitudinal axis of the container body, each support ring being affixed to the support rods at a different point between the first body end and the second body end.

22. The container of claim 17, wherein each support rod defines a narrowing portion at the second rod end, the narrowing portion extending radially inward from a circumference of the circular cover.
